(19) United States
(12) Patent Application Publication
(10) Pub. No.: US 2026/0077753 A1
(43) Pub. Date: Mar. 19, 2026

(54) BRAKE CONTROL SYSTEM TEST BENCH FOR RAILROAD TRAIN

(71) Applicant: MEISHAN CRRC BRAKE SCIENCE & TECHNOLOGY CO., LTD., Meishan, Sichuan (CN)

(72) Inventors: Wenjun Liu, Meishan, Sichuan (CN); Jiheng Wu, Meishan, Sichuan (CN); Bin Wang, Meishan, Sichuan (CN); Zhiping Ren, Meishan, Sichuan (CN); Xingyu Zhong, Meishan, Sichuan (CN); Jiamin Zhao, Meishan, Sichuan (CN); Yitao Luo, Meishan, Sichuan (CN); Sheng Wang, Meishan, Sichuan (CN)

(21) Appl. No.: 19/110,094

(22) PCT Filed: Nov. 13, 2023
(86) PCT No.: PCT/CN2023/131309

§ 371 Date: Mar. 10, 2025

(30) Foreign Application Priority Data
May 29, 2023 (CN) 202310610289.8

(51) Int. Cl. B60T 17/22

(52) U.S. Cl. CPC B60T 17/228

(57) ABSTRACT

Provided is a brake control system test bench for a railroad train, including a brake controller, a plurality of brake cabinets, a plurality of air source systems, and a plurality of locomotive synchronous control systems. Each brake cabinet is configured to control the locomotive braking machine to act according to instructions of the brake controller. Each locomotive synchronous control system is configured to control the corresponding brake cabinet to simulate a formation of a main-control locomotive or slave-controlled locomotive group, and to control the slave-controlled locomotive to respond to the instructions of the main-control locomotive and to follow the main-control locomotive to generate the same action, so as to simulate the locomotive to carry out tests of centralized traction, dispersed traction, and head and tail interchange of the locomotive.

### CROSS-REFERENCE TO RELATED APPLICATION

The present disclosure claims priority to Chinese patent application No. 202310610289.8, filed with the Chinese Patent Office on May 29, 2023, entitled “BRAKE CONTROL SYSTEM TEST BENCH FOR RAILROAD TRAIN”, the entire contents of which are incorporated herein by reference.

### TECHNICAL FIELD

The present disclosure relates to the technical field of rail transportation, and specifically to a brake control system test bench for a railroad train.

### BACKGROUND ART

With the continuous development of railroad heavy haul transport in China, 10,000-ton and 20,000-ton heavy haul freight trains have been regularly run, and it has been put a clear requirement for the running of the 30,000-ton heavy haul train. Before the train can run, various tests need to be passed. It is necessary to carry out comprehensive and systematic theoretical research and experimental verification on aspects of the grouping method, brake system control technology, and wheel relationship of the heavy haul train, and of the interrelationship between the train braking capacity and train longitudinal force. The train braking test bench is a device specially used for the train test. The prior train braking test bench can only carry out the test for trains with a group of 10,000 tons and less, and it has the following shortcomings. It can only carry out the test for trains with a group of 10,000 tons and less, and the number of groups and the number of brake cabinets of the train cannot match working conditions in actual use; it cannot carry out the test for trains more than 10,000 tons, so that it lacks convincing to experimental data for the failure simulation for the train more than 10,000 tons; it cannot simulate the test synchronously controlling multiple brake cabinets; and it cannot simulate centralized traction test status of multiple locomotives.

### SUMMARY

The object of the present disclosure includes, for example, providing a brake control system test bench for the railroad train, which can simultaneously control a plurality of brake cabinets to act and can simulate a plurality of train brake systems to test, so as to meet the test requirements for the train more than 10,000 tons, and the test data is more authentic and convincing; and in the process of the test, it can simulate different forms of locomotive group tests.

The embodiments of the present disclosure can be realized in the following ways.

The present disclosure provides a brake control system test bench for the railroad train, including:
a brake controller, wherein the brake controller is configured to control whole train braking and individual locomotive braking, and the brake controller is connected to a train pipe by a pipeline;
a plurality of brake cabinets, wherein the plurality of brake cabinets all are electrically connected to the brake controller; each brake cabinet is electrically connected to a brake display; they simulate a locomotive braking machine together; and each brake display is configured to display work information of the corresponding brake cabinet, wherein each brake cabinet is configured to change a pressure in the train pipe according to an instruction of the brake controller, to control the locomotive braking machine to act, and to control the locomotive itself to generate a braking or relieving function at the same time;
a plurality of air source systems, wherein each brake cabinet is connected to at least one air source system, and each air source system is configured to provide an air source to the corresponding brake cabinet; and
a plurality of locomotive synchronous control systems, wherein each locomotive synchronous control system is electrically connected to a brake cabinet; each locomotive synchronous control system is configured to control the corresponding brake cabinet to simulate a formation of a main-control locomotive or slave-controlled locomotive group, and to control the slave-controlled locomotive to respond instructions of the main-control locomotive and to follow the main-control locomotive to generate the same action, so as to simulate the locomotive to carry out tests of centralized traction, dispersed traction, and head and tail interchange of the locomotive.

In an optional embodiment, the brake display is configured to display a total air pressure value, a train pipe pressure value, a balanced air cylinder pressure value, a front-and-rear brake cylinder pressure value, a supplying air flow value, and fault information.

In an optional embodiment, the brake control system test bench for the railroad train includes five brake cabinets, five brake displays, and five locomotive synchronous control systems, wherein
the five brake cabinets, five brake displays, and five locomotive synchronous control systems are in one-to-one correspondence.

In an optional embodiment, the brake control system test bench for the railroad train includes ten air source systems, wherein each brake cabinet is connected to two air source systems.

In an optional embodiment, the brake controller is configured on the main-control locomotive.

In an optional embodiment, the brake control system test bench for the railroad train further includes a console, wherein the console is connected to the main-control locomotive, and the brake controller, the brake display, and the locomotive synchronous control system are all connected to the console.

In an optional embodiment, the brake control system test bench for the railroad train further includes a backup brake valve and a backup brake module, wherein
in case of an electrical failure of the brake controller, the backup brake valve is configured to connect to a balanced air cylinder of the brake cabinet by the backup brake module, so as to realize air intake for relieving and air exhaust and pressure reducing for brake of the balanced air cylinder.

In an optional embodiment, the backup brake valve and the backup brake module are both connected to the console.

In an optional embodiment, the brake control system test bench for the railroad train further includes a centralized traction hose, wherein the centralized traction hose is configured to communicate with the train pipe in a gas circuit when carrying out a centralized traction test.

In an optional embodiment, one of the plurality of brake cabinets is located at a tail part of a train group.

The present disclosure includes the following beneficial effects.

The brake control system test bench for the railroad train can simultaneously control the plurality of brake cabinets to act and can simulate the plurality of train brake systems to test, so as to meet the test requirements for the train more than 10,000 tons, and the test data is more authentic and convincing. During the process of the test, it can simulate different forms of locomotive group tests due to providing with the locomotive synchronous control system, wherein the test forms include 1 master control and 4 slave controls, 1 master control and 3 slave controls, 1 master control and 2 slave controls, and 1 master control and 1 slave control; and it can simulate the locomotive to carry out tests of centralized traction, dispersed traction, and head and tail interchange of the locomotive.

### BRIEF DESCRIPTION OF DRAWINGS

FIG. 1 shows a schematic diagram of a brake control system test bench for the railroad train in the embodiments of the present disclosure;

FIG. 2 shows a schematic diagram of a brake cabinet of a main-control locomotive of a brake control system test bench for the railroad train in the embodiments of the present disclosure; and

FIG. 3 shows a schematic diagram of a brake cabinet of a slave-controlled locomotive of a brake control system test bench for the railroad train in the embodiments of the present disclosure.

### DETAILED DESCRIPTION OF EMBODIMENTS

In order to make the purpose, technical solutions, and advantages of the embodiments of the present disclosure clearer, the technical solutions in the embodiments of the present disclosure will be clearly and completely described in conjunction with the drawings in the embodiments of the present disclosure. It is clear that the embodiments described are partial embodiments of the present disclosure, but not all of the embodiments. The components in the embodiments of the present disclosure generally described and shown in the drawings herein may be arranged and designed in multiple different configurations.

Therefore, the following detailed description of embodiments of the present disclosure provided in the drawings is not intended to limit the scope of the present disclosure for which protection is claimed, but rather represents only selected embodiments of the present disclosure. In conjunction with the embodiments of the present disclosure, all other embodiments obtained by a person of ordinary skill in the art without inventive efforts, shall fall within the scope of protection of the present disclosure.

It should be noted that similar symbols and letters denote similar items in the following drawings, so that once an item is defined in a drawing, no further definition or explanation is required in the subsequent drawings.

In the description of the present disclosure, it should be noted that the orientation or position relationship indicated by the terms, “up”, “down”, “inside”, “outside”, etc., is the orientation or position relationship based on the drawings, or is the orientation or position relationship of the product of the present disclosure customarily placed in use, which are only to facilitate the description of the present disclosure and simplify the description, and are not to indicate or imply that the device or element referred to must have a particular orientation, or be constructed and operated with a particular orientation, and therefore cannot to be understood as limitations of the present disclosure.

Additionally, the terms “first”, and “second”, etc., are configured only to differentiate the description, and are not to be understood as indicating or implying relative importance.

It is to be noted that various features in the embodiments of the present disclosure can be combined with each other without conflict.

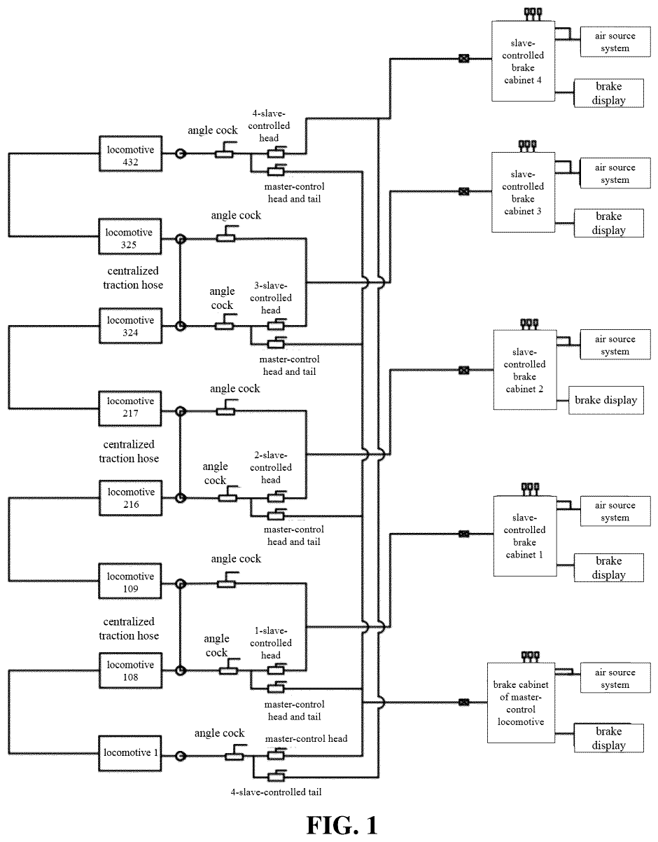

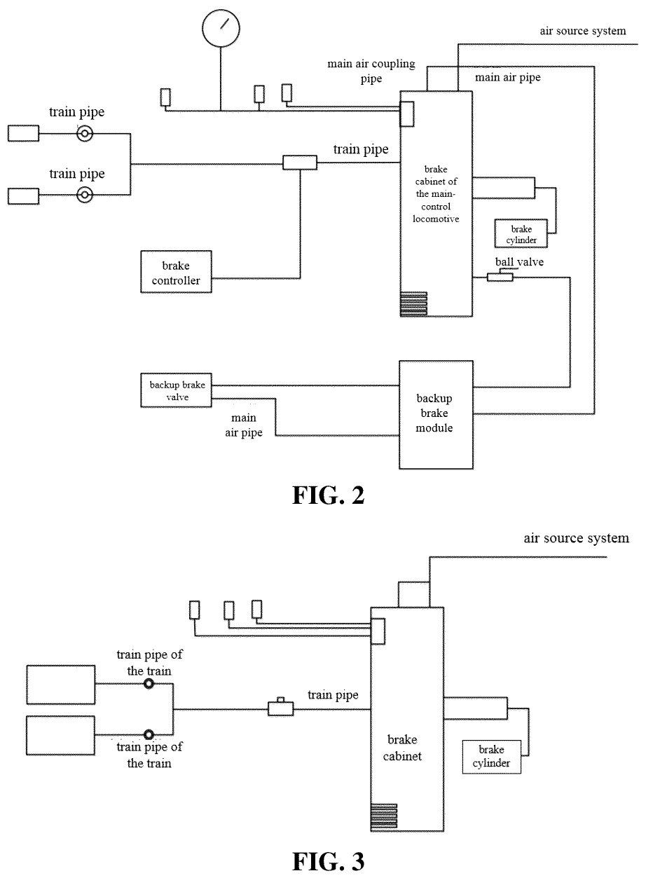

Referring to FIG. 1-FIG. 3, the embodiment provides a brake control system test bench for the railroad train, including a brake controller, a plurality of brake cabinets, a plurality of air source systems, and a plurality of locomotive synchronous control systems, wherein
the brake controller is configured to control whole train braking and individual locomotive braking, and the brake controller is connected to a train pipe by a pipeline;
the plurality of brake cabinets are all electrically connected to the brake controller; each brake cabinet is electrically connected to a brake display; they simulate a locomotive braking machine together; and each brake display is configured to display work information of the corresponding brake cabinet, wherein each brake cabinet is configured to change a pressure in the train pipe according to an instruction of the brake controller, and to control the locomotive braking machine to act, and to control the locomotive itself to generate a braking or relieving function at the same time;
each brake cabinet is connected to at least one air source system, and each air source system is configured to provide an air source to the corresponding brake cabinet; and
each locomotive synchronous control system is electrically connected to a brake cabinet; each locomotive synchronous control system is configured to control the corresponding brake cabinet to simulate a formation of a main-control locomotive or slave-controlled locomotive group, and to control the slave-controlled locomotive to respond to instructions of the main-control locomotive and to follow the main-control locomotive to generate the same action, so as to simulate the locomotive to carry out tests of centralized traction, dispersed traction, and head and tail interchange of the locomotive.

Based on the above structure arrangement, the brake controller is configured on the main-control locomotive. The brake control system test bench for the railroad train further includes a console, a backup brake valve, and a backup brake module. The console is configured to install and fix the brake controller, the brake display, the backup brake valve, the backup brake module, the locomotive synchronous control system, the required electrical buttons, and other components. The console is connected to the main-control locomotive; and the brake controller, the brake display, and the locomotive synchronous control system are all connected to the console. In case of an electrical failure of the brake controller, the backup brake valve is configured to connect to a balanced air cylinder of the brake cabinet by the backup brake module, so as to realize air intake for relieving and air exhaust and pressure reducing for brake of the balanced air cylinder. Additionally, one of the plurality of brake cabinets is located at a tail part of the train group.

Referring to FIG. 1-FIG. 3, based on the above, when configuring the brake controller, the brake controller has two operating handles including an automatic brake control (big brake) handle and an individual brake control (small brake) handle, which are configured to control the whole train braking and the individual locomotive braking, and the brake controller is configured only on the main-control locomotive. The brake controller is connected to the train pipe by a pipeline, and the brake cabinet can be triggered to play an emergency braking function. The brake controller is electrically connected to the control module in the brake cabinet to exchange information and transmit instructions.

When configuring the brake display, the brake display is configured to display a total air pressure value, a train pipe pressure value, a balanced air cylinder pressure value, a front-and-rear brake cylinder pressure value, a supplying air flow value, and fault information, etc. Further, the brake display is electrically connected to the control module in the brake cabinet to exchange information and modify control parameters.

When configuring the brake cabinet, the brake cabinet can change a pressure in the train pipe according to the instruction of the brake controller, and to control the locomotive braking machine to act, and to control the locomotive itself to generate a braking or relieving function at the same time. The brake cabinet is electrically connected to the brake display and the brake controller to transmit the information. The brake cabinet is connected to the train brake system, the brake controller, the backup brake valve, and the backup brake module by the train pipe.

When configuring the air source system, in the air source system, a main air tube and main air coupling tubes of the brake cabinet are formed by the pipeline, so as to provide a total air pressure for the brake cabinet and constitute a source of the train pipe pressure for the train brake system.

When configuring the locomotive synchronous control system, the locomotive synchronous control system can control five brake cabinets to simulate the formation of main-control and slave-controlled locomotive groups; the slave-controlled locomotive can respond to the instructions of the main-control locomotive and follow the main-control locomotive to generate the same action; and the response duration can be set through the locomotive synchronous control system at a level of 0.1 s. According to the test requirements, the brake cabinets can simulate the locomotive groups of 1 main control and 4 slave controls, 1 main control and 3 slave controls, 1 main control and 2 slave controls, and 1 main control and 1 slave control.

In summary, referring to FIG. 1-FIG. 3, the working principle of the brake control system test bench for the railroad train is as follows.

When each device is started, the air source system provides a total air pressure for each main-control and slave-controlled locomotive;
the locomotive synchronous control system controls the locomotive braking machine to form the master-control and slave-controlled locomotive groups;
the brake controller is controlled to generate different instruction signals at different positions; the main-control brake cabinet controls the balanced air cylinder and the train pipe to produce pressure changes according to the instruction signal, and transmits the change to the train group, so that the locomotive braking machine generates braking, pressure preservation, and relief actions;
the locomotive synchronous control system transmits the instruction signals of the main-control locomotive to other slave-controlled locomotives, so that the slave-controlled locomotives follow the main-control locomotive to control the train pipe to generate the same pressure change, so as to accelerate the propagation speed of the braking signals in the train group and to reduce the longitudinal impact force; and
through changing the opening and closing states of different ball valves in the pipeline of the train pipe of the master-control and slave-controlled locomotives, it can perform the tests of centralized traction, dispersed traction, and locomotive head and tail interchange for the locomotives.

Therefore, the brake control system test bench for the railroad train can simultaneously control the plurality of brake cabinets to act and can simulate the plurality of train brake systems to test, so as to meet the test requirements for the train more than 10,000 tons, and the test data is more authentic and convincing.

During the process of the test, it can simulate different forms of locomotive group tests due to providing with the locomotive synchronous control system, wherein the test forms include 1 master control and 4 slave controls, 1 master control and 3 slave controls, 1 master control and 2 slave controls, and 1 master control and 1 slave control, and it can simulate the locomotive to carry out tests of centralized traction, dispersed traction, and head and tail interchange of the locomotive.

It is to be noted that based on the above content, it is known that the brake control system test bench for the railroad train can simultaneously control the plurality of brake cabinets to act; and based on the above structure arrangement, the brake control system test bench for the railroad train can be configured for the braking test of the railroad train more than 30,000 tons. Thereby, in the embodiment, it takes a brake control system test bench for the railroad train as an example, which includes five brake cabinets, five brake displays, five locomotive synchronous control systems, and ten air source systems, wherein the five brake cabinets, five brake displays, and five locomotive synchronous control systems are in one-to-one correspondence, and each brake cabinet is connected to two air source systems.

Additionally, besides the above structure, the brake control system test bench for the railroad train further includes a centralized traction hose, a pipeline, an angle cock, a ball valve (a master-control head, the master-control head and tail, 1-slave-controlled head, 2-slave-controlled head, 3-slave-control head, 4-slave-controlled head, 4-slave-controlled tail), and other components, wherein the centralized traction hose is configured communicate with the train pipe in a gas circuit when carrying out the centralized traction test; and the pipeline, the angle cock, and the ball valve are configured communicate with the train pipe of each train and realize the conduction control, so as to facilitate the control of the actual working condition for the train according to the specific condition when realizing the conduction.

Referring to FIG. 1-FIG. 3, when carrying out the dispersed traction test for the brake control system test bench for the railroad train, the grouping method of the locomotives and the trains is: a main-control locomotive+a train of 10,000 tons+a slave-controlled locomotive+a train of 10,000 tons+a slave-controlled locomotive+a train of 10,000 tons+a slave-controlled locomotive+a train of 10,000 tons+a slave-controlled locomotive; and
the gas circuit direction is: a main-control locomotive→a master-control head→an angle cock→locomotive 1→locomotive 108→an angle cock→1-slave-controlled head→the slave-controlled locomotive 1↔an angle cock→locomotive 109→locomotive 216→an angle cock→2-slave-controlled head↔the slave-controlled locomotive 2↔an angle cock →locomotive 217→locomotive 324→an angle cock→3-slave-controlled head↔the slave-controlled locomotive 3↔an angle cock→locomotive 325→locomotive 432→an angle cock→4-slave-controlled head↔the slave-controlled locomotive 4.

Referring to FIG. 1-FIG. 3, when carrying out the centralized traction test for the brake control system test bench for the railroad train, the grouping method of the locomotives and the trains is: a main-control locomotive+a slave-controlled locomotive+a slave-controlled locomotive+a slave-controlled locomotive+a train of 10,000 tons+a train of 10,000 tons+a train of 10,000 tons+a train of 10,000 tons, wherein two adjacent trains of 10,000 tons are connected by the centralized traction hose.

The gas circuit direction is: the slave-controlled locomotive 1→1-slave-controlled head →the master-control head and tail→the master-control head; the slave-controlled locomotive 2→2-slave-controlled head→the master-control head and tail→the master-control head; the slave-controlled locomotive 3→3-slave-controlled head→the master-control head and tail→the master-control head; the slave-controlled locomotive 4→4-slave-controlled head→the master-control head and tail→the master-control head; and the main-control locomotive→the master-control head→an angle cock→locomotive 1→locomotive 108→the centralized traction hose →locomotive 109→locomotive 216→the centralized traction hose→locomotive 217 →locomotive 324→the centralized traction hose->locomotive 325→locomotive 432.

Referring to FIG. 1-FIG. 3, when carrying out the head and tail interchange test for the brake control system test bench for the railroad train, the grouping method of the locomotives and the trains is: changing the air supply positions of the head train and the tail train constituted of the main-control locomotive, one unit of trains of 10,000 tons, 2 units of trains of 10,000 tons, 3 units of trains of 10,000 tons, and 4 units of trains of 10,000 tons.

A. The gas circuit direction of the control locomotive and the one unit of trains of 10,000 tons:
the regular direction, the main-control locomotive→the master-control head→an angle cock→locomotive 1→locomotive 108;
the head and tail interchange direction, the main-control locomotive→the master-control head and tail→an angle cock→locomotive 108→locomotive 1.

B. The gas circuit direction of the control locomotive and 2 units of trains of 10,000 tons:
the regular direction, the main-control locomotive→the master-control head→an angle cock→locomotive 1→locomotive 108→an angle cock→1-slave-controlled head↔the slave-controlled locomotive 1→an angle cock→locomotive 109→locomotive 216; and
the head and tail interchange direction, the main-control locomotive→the master-control head and tail→an angle cock→locomotive 216→locomotive 109→an angle cock↔the slave-controlled locomotive 1↔1-slave-controlled head→an angle cock→locomotive 108 →locomotive 1.

C. The gas circuit direction of the control locomotive and 3 units of trains of 10,000 tons:
the regular direction, the main-control locomotive→the master-control head→an angle cock→locomotive 1→locomotive 108→an angle cock→1-slave-controlled head↔the slave-controlled locomotive 1↔an angle cock→locomotive 109→locomotive 216→an angle cock→2-slave-controlled head↔the slave-controlled locomotive 2↔an angle cock→locomotive 217→locomotive 324; and
the head and tail interchange direction, the main-control locomotive→the master-control head and tail→an angle cock→locomotive 324→locomotive 217→an angle cock↔the slave-controlled locomotive 2→2-slave-controlled head→an angle cock→locomotive 216 →locomotive 109→an angle cock↔the slave-controlled locomotive 1↔1-slave-controlled head →an angle cock→locomotive 108→locomotive 1.

D. The gas circuit direction of the control locomotive and 4 units of trains of 10,000 tons:
the regular direction, the main-control locomotive→the master-control head→an angle cock→locomotive 1→locomotive 108→an angle cock→1-slave-controlled head↔the slave-controlled locomotive 1↔an angle cock→locomotive 109→locomotive 216→an angle cock→2-slave-controlled head↔the slave-controlled locomotive 2↔an angle cock→locomotive 217→locomotive 324→an angle cock→3-slave-controlled head↔the slave-controlled locomotive 3↔an angle cock→locomotive 325→locomotive 432→an angle cock→4-slave-controlled head↔the 4-slave-controlled locomotive; and
the head and tail interchange direction, the main-control locomotive→the master-control head and tail→an angle cock→locomotive 432→locomotive 325→an angle cock↔the slave-controlled locomotive 3↔3-slave-control head→an angle cock→locomotive 324→locomotive 217→an angle cock↔the slave-controlled locomotive 2↔2-slave-controlled head →an angle cock→locomotive 216→locomotive 109→an angle cock↔the slave-controlled locomotive 1↔1-slave-controlled head→an angle cock→locomotive 108→locomotive 1→an angle cock→the 4-slave-controlled tail.

Referring to FIG. 1-FIG. 3, the brake control system test bench for the railroad train has the following advantages.

It can simultaneously control 5 brake cabinets to act and can simulate the brake system of 432 locomotives to test, so as to meet the test requirements for the train more than 10,000 tons, and the test data is more authentic and convincing.

It can simulate different forms of locomotive group tests due to providing with the locomotive synchronous control system, wherein the test forms include 1 master control and 4 slave controls, 1 master control and 3 slave controls, 1 master control and 2 slave controls, and 1 master control and 1 slave control.

The duration of the slave-controlled locomotive responding to the main-control locomotive can be set by the locomotive synchronous control system at a level of 0.1 s.

One brake cabinet can be placed at the tail of the train group, which can simulate the test of a real locomotive being placed at the tail of the train, so as to improve the relief consistency of the train.

It can simulate the locomotive to carry out tests of centralized traction, dispersed traction, and head and tail interchange of the locomotive.

It should also be noted that the brake control system is consisted of the brake controller, the brake cabinets, and the locomotive synchronous control system together, and the locomotive synchronous control system is controlled by a special software, which can set the response duration of the slave-controlled locomotive. The train pipes of all brake cabinets are connected in series and then connected to the train brake system by the centralized traction hoses or other method, so as to realize the centralized traction function.

The foregoing are only the embodiments of the present disclosure, but the scope of protection of the present disclosure is not limited thereto. Any technical personnel familiar with the technical field can easily think of changes or replacements within the technical scope of the present disclosure, shall be covered by the scope of protection of the present disclosure. Therefore, the scope of protection of the present disclosure shall be governed by the scope of protection of the claims.

### INDUSTRIAL APPLICABILITY

The brake control system test bench for the railroad train can simultaneously control the plurality of brake cabinets to act and can simulate the plurality of train brake systems to test, so as to meet the test requirements for the train more than 10,000 tons, and the test data is more authentic and convincing; and during the process of the test, it can simulate different forms of locomotive group tests due to providing with the locomotive synchronous control system, wherein the test forms include 1 master control and 4 slave controls, 1 master control and 3 slave controls, 1 master control and 2 slave controls, and 1 master control and 1 slave control, and it can simulate the locomotive to carry out tests of centralized traction, dispersed traction, and head and tail interchange of the locomotive.

1. A brake control system test bench for a railroad train, comprising:
a brake controller, wherein the brake controller is configured to control whole train braking and individual locomotive braking, and the brake controller is connected to a train pipe by a pipeline;
a plurality of brake cabinets, wherein the plurality of brake cabinets all are electrically connected to the brake controller; each of the brake cabinets is electrically connected to one brake display; each of the brake cabinets and the brake display simulate one locomotive braking machine together; and each brake display is configured to display work information of a corresponding brake cabinet; each of the brake cabinets is configured to change a pressure in the train pipe according to an instruction of the brake controller, and to control the locomotive braking machine to act, and to control a locomotive itself to generate a braking or relieving function at the same time;
a plurality of air source systems, wherein each of the brake cabinets is connected to at least one of the air source systems, and each air source system is configured to provide an air source to a corresponding brake cabinet; and
a plurality of locomotive synchronous control systems, wherein each of the locomotive synchronous control systems is electrically connected to one of the brake cabinets; each of the locomotive synchronous control systems is configured to control a corresponding brake cabinet to simulate a formation of a main-control locomotive or slave-controlled locomotive group, and to control the slave-controlled locomotive to respond to instructions of the main-control locomotive and to follow the main-control locomotive to generate the same action, so as to simulate the locomotive to carry out tests of centralized traction, dispersed traction, and head and tail interchange of the locomotive.

2. The brake control system test bench for the railroad train according to claim 1, wherein
the brake display is configured to display a total air pressure value, a train pipe pressure value, a balanced air cylinder pressure value, a front-and-rear brake cylinder pressure value, a supplying air flow value, and fault information.

3. The brake control system test bench for the railroad train according to claim 1, wherein
the brake control system test bench for the railroad train comprises the plurality of brake cabinets, the plurality of brake displays, and the plurality of locomotive synchronous control systems, wherein
the plurality of brake cabinets, the plurality of brake displays, and the plurality of locomotive synchronous control systems are in one-to-one correspondence.

4. The brake control system test bench for the railroad train according to claim 3, wherein
the brake control system test bench for the railroad train comprises five brake cabinets, five brake displays, and five locomotive synchronous control systems, wherein
the five brake cabinets, the five brake displays, and the five locomotive synchronous control systems are in one-to-one correspondence.

5. The brake control system test bench for the railroad train according to claim 4, wherein
the brake control system test bench for the railroad train comprises the plurality of air source systems, wherein each of the brake cabinets is connected to at least one of the air source systems.

6. The brake control system test bench for the railroad train according to claim 5, wherein
the brake control system test bench for the railroad train comprises ten air source systems, wherein each of the brake cabinets is connected to at least one of the air source systems.

7. The brake control system test bench for the railroad train according to claim 6, wherein
the brake control system test bench for the railroad train comprises ten air source systems, wherein each of the brake cabinets is connected to two of the air source systems.

8. The brake control system test bench for the railroad train according to claim 1, wherein
the brake controller is configured on the main-control locomotive.

9. The brake control system test bench for the railroad train according to claim 8, wherein
the brake control system test bench for the railroad train further comprises a console, wherein the console is connected to the main-control locomotive, and the brake controller, the brake displays, and the locomotive synchronous control systems are all connected to the console.

10. The brake control system test bench for the railroad train according to claim 9, wherein
the brake control system test bench for the railroad train further comprises a backup brake valve and a backup brake module, wherein
in case of an electrical failure of the brake controller, the backup brake valve is configured to connect to a balanced air cylinder of the brake cabinet by the backup brake module, so as to realize air intake for relieving and air exhaust and pressure reducing for brake of the balanced air cylinder.

11. The brake control system test bench for the railroad train according to claim 10, wherein
the backup brake valve and the backup brake module are both connected to the console.

12. The brake control system test bench for the railroad train according to claim 1, wherein
the brake control system test bench for the railroad train further comprises a centralized traction hose, and the centralized traction hose is configured to communicate with the train pipe in a gas circuit when carrying out a centralized traction test.

13. The brake control system test bench for the railroad train according to claim 1, wherein
the brake control system test bench for the railroad train further comprises an angle cock, and the angle cock is configured to communicate with the train pipe of each train when carrying out a centralized traction test, and to realize a conduction control.

14. The brake control system test bench for the railroad train according to claim 1, wherein
the brake control system test bench for the railroad train further comprises a ball valve, and the ball valve is configured to communicate with the train pipe of each train when carrying out a centralized traction test, and to realize a conduction control.

15. The brake control system test bench for the railroad train according to claim 1, wherein
one of the plurality of brake cabinets is located at a tail part of a train group.

16. The brake control system test bench for the railroad train according to claim 2, wherein
the brake control system test bench for the railroad train comprises the plurality of brake cabinets, the plurality of brake displays, and the plurality of locomotive synchronous control systems, wherein
the plurality of brake cabinets, the plurality of brake displays, and the plurality of locomotive synchronous control systems are in one-to-one correspondence.

17. The brake control system test bench for the railroad train according to claim 2, wherein
the brake controller is configured on the main-control locomotive.

18. The brake control system test bench for the railroad train according to claim 2, wherein
the brake control system test bench for the railroad train further comprises a centralized traction hose, and the centralized traction hose is configured to communicate with the train pipe in a gas circuit when carrying out a centralized traction test.

19. The brake control system test bench for the railroad train according to claim 2, wherein
the brake control system test bench for the railroad train further comprises an angle cock, and the angle cock is configured to communicate with the train pipe of each train when carrying out a centralized traction test, and to realize a conduction control.

20. The brake control system test bench for the railroad train according to claim 2, wherein
the brake control system test bench for the railroad train further comprises a ball valve, and the ball valve is configured to communicate with the train pipe of each train when carrying out a centralized traction test, and to realize a conduction control.
